(19) United States
(12) Patent Application Publication
(10) Pub. No.: US 2012/0196239 A1
(43) Pub. Date: Aug. 2, 2012

(54) METHOD AND DEVICE FOR COOLING A FINE GRAINED SOLID BULK WHILE EXCHANGING THE OPEN SPACE GAS CONTAINED THEREIN SIMULTANEOUSLY

(75) Inventor: Stefan Hamel, Wenden (DE)

(73) Assignee: THYSSENKRUPP UHDE GMBH, Dortmund (DE)

(21) Appl. No.: 13/388,676

(22) PCT Filed: Aug. 3, 2010
(86) PCT No.: PCT/EP2010/004736

§ 371 Date: Mar. 6, 2012

(30) Foreign Application Priority Data
Aug. 5, 2009 (DE) 10 2009 036 119.7

(51) Int. Cl. F24F 7/04; F28D 15/00; F27D 3/00

(52) U.S. Cl. 432/9; 454/284; 165/104.19

(57) ABSTRACT

A device for cooling the solid matter from a coal gasification. The device includes a container with a feed part, a cooling part and a venting part. Lines arranged transverse to the flow direction are located inside of the cooling part that are grouped in two kinds, the one carrying liquid and the other carrying gas. The liquid carrying lines are closed in the interior of the cooling part and are provided for the heat exchange. The gas carrying lines that are gas permeable into the interior of the cooling part in such a way that solid matter comprising primarily cooled slag, ash and flue dust is cooled and the remaining gas present in and between the solid matter particles is exchanged. A method for cooling down the solid matter and for removing the remaining gas from the particles is also disclosed.

The invention relates to a contrivance for the cooling of a fine-grained and hot bulk charge from a coal gasification unit with simultaneous exchange of the void space gas, this contrivance, in principle, also being able to be used for the cooling of bulk charges from other raw gas production processes, in particular, however, being suitable for the cooling of fly ash obtained from coal gasification processes, because the fly ash still contains portions of coal gasification gas or raw gas between and inside the particles which can be removed by the inventive contrivance, a gas securing maintenance of the free-flow properties of the solid matter to be cooled, typically being in the form of a charge, simultaneously flowing around the solid matter to be cooled. The invention also relates to a process for the cooling of hot solids, the said process being in particular usable for separated fly ash from a coal gasification process.

As regards the gasification of coal or carbon-containing solids, the starting solid matter is converted by an oxygen-containing or oxygen-containing and water vapour-containing gas into synthesis gas which mainly consists of carbon monoxide and hydrogen and contains solids in the form of fly dust mainly consisting of the ash contained in the coal and/or solidified slag. The content of solids varies in dependence of the fuel used. For the production of synthesis gas it is, in principle, possible to also use other carbon-containing fuels than coal. Other suitable carbon-containing fuels suited for the production of synthesis gas are, for example, peat, hydrogenation residues, other residues, waste, biomass or mixtures of these substances and mixtures with coal. Depending on the fuel used the synthesis gas produced by gasification has a varying content of solids which is separated by suitable devices and must be cooled.

Suitable devices for the separation are, for example, cyclones, filters or electrostatic precipitators. The solid matter mainly consisting of fly ash is of hot state, typically in the form of a charge, and must be cooled prior to further use or disposal. A charge signifies in particular a dense mixture of solid particles with gas contained between the latter. The separated solid matter also contains considerable amounts of raw and toxic synthesis gas in the interspaces between the particles and in the void spaces of the particles, the said synthesis gas having to be removed prior to further use or disposal of the solid.

For the purpose of solids cooling there are state-of-the-art solids coolers which typically consist of vessels allowing the bulk charge to be cooled to trickle through and the inside of which is equipped with tubes arranged at an angle to the flow direction, the said tubes being passed by a thermally conductive liquid and cooling down the solid matter to a lower temperature as it trickles by. Also suitable as cooling devices are cooled impact surfaces or lines conveying a thermally conductive liquid and having a rectangular cross-section. These devices are, for example, designed as liquid-conducting hollow bodies.

DE 102006045807 A1 describes a contrivance for the cooling of fluidised or free-flowing bulk materials, the said contrivance being designed as a heat exchanger which cools down the bulk materials to be cooled to a lower temperature by liquid-conducting tubes, the said tubes being arranged offset with respect to one another in successive tube rows. The tubes are aligned through the tube rows obliquely with respect to the tube rows, the said rows being passed by suitable cooling or heating agents. Devices for the supply of heating or cooling agents are provided at one end of the tube rows and devices for the discharge of said agents are provided at the other end. The bulk material to be cooled is directed through the heat exchanger at an angle to the tube rows. The tube rows are grouped in modules, the said modules engaging into one another when being joined together on account of the offset arrangement of the tubes in the tube rows. This facilitates a useful horizontal or vertical piling of the modules to meet the different performance requirements during operation.

EP 934498 B1 describes a shaft cooler for grained or free-flowing bulk materials, which consists of a supply section, a cooling section and a discharge section for the solid matter to be cooled. The cooling section typically consists of a rectangular-cuboid vessel, the inside of which is equipped with tubes arranged obliquely with respect to the flow direction, the said tubes being arranged inside the cooling section between two opposite walls and through which a cooling agent, such as air or water, is passed. The tubes are grouped in tube bundles which are arranged horizontally between the opposite lateral walls and in several stacked rows.

The described contrivances are effective for solids cooling but they have the disadvantage that the void space gas in and between the particles is not exchanged or removed. The described contrivances are also susceptible to plugging unless free-flowing bulk charges are used.

The state-of-the-art shaft coolers with tube bundles or hollow bodies require a free-flowing bulk charge in any case. The fly ash in the focus of the present invention, however, clearly has different properties to be met to a special degree to ensure the smooth operation of a cooling device. The fly ash is characterised by a small average particle size, e.g. in the range of 2 to 6 micrometers, and is additionally provided with a particle size distribution which may contain considerably smaller particles. Applying the classification of gas/solid systems according to Geldart (D. Geldart, Powder Techn. 7, 285-293, 1973) used to describe the fluidisation behaviour, the fly ash would typically belong to Geldart's group C or be in the transition to Geldart's group A. Geldart's group C comprises materials which are noticeably cohesive.

Standard fluidisation is extremely difficult. In tubes of small diameter, the charge is raised as a whole by the gas. The gas blows free individual channels only. In the case of vessels of larger diameter the charge is not raised, thus causing the local ruptures of channels, preferably near walls. This stems from the fact that the adhesive forces between the particles are larger than the forces exerted by the gas. Geldart's group A comprises materials of small particle size and/or low density (e.g. catalysts used for cracking). Fluidised beds of this particles group clearly extend above the minimum fluidisation point before bubbles will form. If the gas supply is stopped, the bed will collapse very slowly and considerable gas retention capacity is significant. The particles commonly termed free-flowing are represented by Geldart's groups B and D. Geldart' group D comprises materials of coarse and/or heavy particles. Most materials correspond to Geldart's group B. Both groups can be fluidised easily and do not show any gas retention capacity.

DE 1583505 C3 teaches a cooling unit for the hot material leaving the rotary kiln and used for the burning or sintering of unformed or granular masses, consisting of a cooling shaft according to patent DE 1558609 A, characterised in that coarse crushing rolls for the crushing of larger lumps are arranged above the crushing rolls supporting the material column in the cooling shaft and said coarse crushing rolls may be cooled if required. In an embodiment of the invention roof-shaped sections, for example of triangular cross-section, are arranged above the coarse crushing rolls for pressure relief of the latter and said roof-shaped sections may be cooled by air or water if required. A possibility for indirect cooling using a cooling agent is not described. The cooling air is supplied via a supply line at the lower end of the cooling unit such that an efficient gas exchange of the gas in the interspaces of the particles is not possible.

DE 3922764 A1 teaches a process and a contrivance for the separation of solid matter from a hot gas by means of a non-centrifugal separator with a collecting bin located underneath. A gas is passed through the solid matter which has been separated and collected in the collecting bin, the solid matter being directly cooled. The heated gas is conveyed through the separator together with the gas freed from the solid. The process and the contrivance disclosed do not allow for an indirect cooling of the solid. Moreover, the cooling gas cannot continuously be supplied in such a way that the solid is fluidised and caking prevented.

U.S. Pat. No. 2,276,496 A describes a process for the cooling of material for heat treatment, comprising, for example, calcining and sintering, in rotary furnaces as used in the limestone, the cement or the related industries and particularly relates to media for cooling the calcined or sintered material removed from the furnace. For cooling, air or a gaseous medium can be injected to the solid to be cooled in several stages. Options for indirect cooling using a cooling agent are not taught. It is also not possible to use the process for the removal of syngas since the gaseous medium is air and an inert gas cannot be supplied. Finally, for running the process a contrivance is used which is of the stationary type and is therefore not compatible with every plant type.

The contrivances or processes mentioned admittedly allow a displacement of part of the void space gas but are not suitable for the types of solids mentioned. It is therefore the objective to provide a contrivance which cools down a hot bulk charge which contains raw gas in the interspaces and gaps of the particles and which facilitates an exchange or a removal of the raw gas contained. It should be possible to adapt the contrivance to different performance requirements of a coal gasification reactor and to use it especially in cases where the bulk charged to be cooled is a fine-grained or dustlike bulk material of poor flow properties. The contrivance should be insensitive to high temperatures and not prone to corrosion in the case of any aggressive harmful substances contained in the bulk charge to be cooled. The contrivance should also be of versatile use although cooling of bulk charges from coal gasification processes is the preferred application.

The invention achieves the objective by a contrivance consisting of a vessel which is divided into a supply section for the hot bulk charge, a cooling section and a discharge section for the cooled bulk charge, and which is passed through by the bulk charge to be cooled. The cooling section is equipped with lines arranged obliquely to the flow direction, the said lines being grouped into two types, one type of lines conventionally being passed by a thermally conductive liquid or cooling agent, and the other type of lines being permeable to gas towards the inside of the vessel, such that a gas can flow to the inside of the vessel and to the solids bed, with the cross-section of at least one gas-conducting line inside the vessel being extended in flow direction of the solids such that a line flattened in the cross-section is formed.

The gas introduced into the charge causes the following:
The supplied gas causes a reduction in the wall friction of the bulk charge on the gas-permeable surfaces. The solid can flow off from the gas-permeable surfaces or simply flow around them.
The gas supply causes a local loosening of the charge which may lead to local fluidisation depending on the amount of gas. The gas supply and the related loosening and dilution cause an improvement of the flow properties of the bulk material, such that even the very fine fly ash considered here can pass the contrivance.
The supplied gas causes a dilution and exchange of the void space gas and thus also of the residual raw gas components between the particles.

The discharge section comprises inlet nozzles for further gas, the said section ensuring good free-flow properties of the discharged bulk charge.

The inventive contrivance can also be designed such that the thermally conductive lines or the gas-permeable lines are, for example, designed as lines or line elements which are of a rectangular cross-section or shaped as liquid-conducting or gas-conducting hollow bodies such that the contrivance can be adapted to changed solids properties or changed performance requirements of the solids cooler.

The invention particularly claims a solids cooler as a contrivance for the cooling of a hot fine-grained bulk charge with simultaneous exchange of the void space gas contained between the bulk particles and inside their pores, comprising
a vessel which serves as cooling section, at least one supply opening being arranged on the one side and at least one discharge for the bulk charge passing through being arranged on the opposite side,
the inside of the vessel being equipped with a first type of lines which are closed towards the inside of the vessel and can be passed through by a fluid, thus facilitating an indirect heat exchange between the fine-grained bulk charge and the void space gas surrounding the latter and the fluid passing through the lines, and
the inside of the vessel being equipped with a second type of lines which are permeable to gas towards the inside of the vessel and can be passed through by a gas which can permeate into the inside of the vessel through openings, and
the vessel being equipped with a gas relief nozzle for the gas introduced by the second type of lines into the inside of the vessel as well as for the void space gas thus displaced, and
the cross-section of at least one gas-conducting line inside the vessel being extended in flow direction of the solids such that a line flattened in the cross-section is formed.

By providing a gas-conducting line with flattened cross-section it is possible to achieve optimum heat exchange and optimum gas supply into the bulk charge, as a result of which, on the one hand, the void space gas is exchanged and, on the other hand, the flow behaviour of the bulk charge is affected to a favourable degree. In this way it is possible to cool bulk material of poor flow properties at high temperature. The inventive contrivance is not prone to plugging if solid bulk charges are used which are not free-flowing. Hence it is also possible to cool fly ash which typically belongs to Geldart's group C or may be in the transition to Geldart's group A.

The other fluid-conducting or gas-conducting lines are preferably tubes of a round cross-sectional area. It is also conceivable, however, that the other fluid-conducting or gas-conducting lines are tubes of an angular cross-section. This can also be extended on two sides each such that a rectangular or flattened cross-section is formed. The cross-section of both lines can eventually be of any form. In a particular embodiment, the lines of a rectangular or flattened cross-section can be referred to or designed as fluid-conducting or gas-conducting hollow bodies. The fluid or gas may also be routed through different lines or through any combination of these lines. Essentially determined by the flow properties of the bulk charge and by the heat transfer area required for heat dissipation, an advantageous embodiment may be a combination of lines of a round or rectangular cross-section.

In a typical embodiment the vessel is equipped with a wall which is of double-jacket design and also charged with a heat transfer agent. Therefore, this wall is provided with jacket cooling. In a typical embodiment the cooling agent flows from the double jacket into the cooling lines.

In a preferred embodiment the vessel consists of a supply section, a cooling section and a discharge section for the bulk charge to be cooled. The supply section and the discharge section or both sections are preferably conical components, the larger opening of which is, in each case, assembled to the cooling section. However, other components as commonly used in vessel construction are also conceivable. For example, torispherical heads, semi-ellipsoidal heads or flat ends for the supply section are conceivable. The supply section is always equipped with at least one gas outlet nozzle as gas relief nozzle for the purpose of achieving that the gas displaced by the bulk charge can escape from the supply section. In a typical embodiment the gas relief nozzle and the supply opening for the bulk charge are arranged on the same side. It is possible to provide upstream or downstream of the vessel in flow direction of the solids at least a gas inlet nozzle for gas to be supplied.

The lines in the cooling section are to be arranged such to ensure optimum cooling, optimum gas exchange between the particles and optimum solids flow. In this way it is possible, for example, to arrange the first type of fluid-conducting lines and the second type of gas-conducting lines inside the vessel in rows in flow direction of the solids with reference to the vessel cross-section, the rows of the first type of fluid-conducting lines and of the second type of the gas-conducting lines alternating in flow direction of the bulk charge with reference to the vessel cross-section.

The first type of fluid-conducting lines and the second type of gas-conducting lines inside the vessel with reference to the vessel cross-section, can also be arranged in rows obliquely with respect to the flow direction of the solids, the rows of the fluid-conducting lines and of the gas-conducting lines alternating—with reference to the vessel cross-section—obliquely with respect to the flow direction of the bulk charge. Finally, the first type of fluid-conducting lines and the second type of gas-conducting lines inside the vessel, with reference to the vessel cross-section, can be arranged in zigzag rows with respect to the flow direction of the solids, the rows of the fluid-conducting lines and of the gas-conducting lines alternating in flow direction of the bulk charge.

The fluid-conducting lines for heat exchange and the gas-conducting lines for gas supply are advantageously arranged in such a manner that optimum heat exchange and optimum gas supply in the bulk charge are possible as a result of which, on the one hand, the exchange of the void space gas is effected and, on the other hand, the flow behaviour of the bulk charge is affected to a favourable degree. This also applies to the lines themselves, the design and diameter of which are such to facilitate optimum heat exchange and gas supply. In an embodiment of the inventive contrivance, the diameter of the second type of gas-conducting lines is smaller than the diameter of the first type of fluid-conducting lines for the purpose of improvement.

A variant of the inventive contrivance is designed such that the cross-section of at least one fluid-conducting line inside the vessel is extended in flow direction of the solids such that a line flattened in the cross-section is formed. Another variant of the inventive contrivance is designed such that the cross-section of a gas-conducting line inside the vessel is extended in flow direction of the solids such that a line flattened in the cross-section is formed. It is also possible to design these lines as lines of a rectangular cross-section. In this case, the inventive contrivance is designed in such a manner that at least one line inside the vessel has a rectangular line cross-section with sides extended in flow direction of the solids. Finally, it is also possible to design at least one fluid-conducting line as well as one gas-conducting line as line of a flattened or rectangular cross-section.

In general, the lines of an angular cross-section may be tubes of a non-round cross-section or designed in the form of hollow bodies conveying the heat transfer agent or the gas. In the latter case, it is required that at least part of the gas-conducting hollow bodies or the gas-conducting tubes of a non-round cross-section are designed to be permeable to gas to achieve a gas supply into the bulk charge.

The inside of the lines of a flattened or rectangular cross-section may be of meander structure to improve the flow of the fluid or gas. This particularly applies to an advantageous design of lines of a flattened or rectangular cross-section which are designed as fluid-conducting or gas-conducting hollow bodies. It is possible that the cross-section of at least one fluid-conducting and at least one gas-conducting line inside the vessel is extended in parallel to the flow direction of the solids such that the lines through which the fluid passes have a cross-section of flattened or rectangular form. It is also possible that the cross-section of at least one gas-conducting line and one fluid-conducting line inside the vessel is extended in flow direction of the solids, the fluid-conducting and gas-conducting lines alternating obliquely with respect to the flow direction of the solids.

Another advantageous embodiment of the invention envisages to design part of the lines as lines of a round cross-section and another part of the contrivance as lines of a rectangular cross-section. For this purpose, it is, for example, possible that obliquely to the flow direction of the solids further lines of a round cross-section are located between the fluid-conducting lines of a flattened cross-section in flow direction of the solids, the gas-conducting or fluid-conducting lines of a round cross-section alternating in flow direction of the solids. The order and the number of the lines can be optional.

In an embodiment of the invention there are, in flow direction of the solids, several fluid-conducting or gas-conducting lines of a cross-section flattened in flow direction of the solids. Thus, in an embodiment of the invention it is also possible that, in flow direction of the solids, at least one gas-conducting line or one fluid-conducting line of a round cross-section is arranged between the fluid-conducting or gas-conducting lines of a cross-section flattened in flow direction of the solids and provided in multiple number. These lines can also alternate in flow direction of the solids.

The gas-conducting lines or the gas-conducting hollow lines are made of a material which facilitates to achieve a gas inlet into the bulk charge. This material is preferably a porous material of a pore size which facilitates a gas inlet into the bulk charge to be cooled but does not let the bulk charge enter the gas-conducting lines. In an embodiment of the invention the porous material is a sintered ceramics, porous ceramics, porous plastics or sintered metal permeable to gas. It is also possible to provide the gas-conducting lines for gas supplied into the bulk charge with holes, bores, apertures, slots or the like. The lines are made of a conventional material impermeable to gas and provided with bores, holes, slots, etc. for gas penetration. It is also possible to provide only certain places or sections of the gas-conducting lines in a porous material and the remaining part of the line of a conventional material impermeable to gas.

The fluid-conducting lines or the reactor are made of a material which allows cooling by means of a good heat transfer without any corrosion. The material of the vessel and of the fluid-conducting lines is selected in dependence of the inlet temperature of the bulk charge and of the raw gas components present in the void volume and may be manufactured, for example, from steel resistant to high temperatures.

It is possible to provide an unequal ratio of the external surfaces of the gas-conducting lines and the fluid-conducting lines. Thus, it is possible that the ratio of the external surfaces of the gas-conducting lines to the fluid-conducting lines inside the hollow vessel is 20 to 50 percent. The optimum selection depends on the cooling objective and the flow properties of the bulk charge. If it is a bulk material of comparably good flow properties at high temperatures, the share of the heat transfer area is increased and the share of the gas supply areas reduced. If, on the other hand, it is a not free-flowing bulk charge, the determination of the areas is given by the required gas supply so to ensure a solids flow at any time.

The invention also refers to a process by which a fine-grained hot solid matter, preferably in the form of a bulk charge, is cooled, while the gas between the particles and in the gaps of the particles is exchanged simultaneously.

The invention relates particularly to a process for the cooling of a fine-grained and hot bulk charge with simultaneous exchange of the void space gas contained between the bulk particles and inside their pores, in which
the bulk charge to be cooled is fed to a vessel equipped with lines, and
the bulk charge is continuously moved through the vessel,
a heat transfer agent cooler than the bulk charge flowing through a first type of lines such that an indirect heat exchange between the bulk charge and the heat transfer agent takes place, and
a second type of lines being designed to be permeable to gas which serve to introduce a supplied gas into the vessel and into the bulk charge, and
the void space gas contained between the bulk particles and inside their pores being displaced by the supplied gas and discharged, and
gas can also escape via a gas supply nozzle upstream or downstream of the vessel in direction of the solids, and
the supplied gas is pre-heated up to the temperature of the supplied bulk charge.

The process of gas generation is preferably a coal gasification such that the bulk charge mainly consists of fly ash and solidified slag. However, in principle, it is also possible to use the solids cooler for any process in which a bulk charge to be cooled is obtained, the gas of which in the interspaces or gaps must be exchanged or removed.

The heat exchange agent flowing through the fluid-conducting lines is preferably a liquid, although a gas or a fluid as heat transfer agent is also conceivable. Water is a particularly preferred heat exchange agent.

Conveyance of the bulk charge through the cooler can, in principle, also be carried out in any way desired. Thus, it is possible to have the bulk charge flow by gravity through the solids cooler. In an embodiment of the invention it is also possible to have the bulk charge move through the solids cooler by gravity or by a pressure gradient or by both in combination. For generating the pressure gradient, it is possible, for example, to introduce a gas into the cooler.

In principle, the bulk charge to be cooled may be of any temperature when being supplied into the solids cooler. In an embodiment of the invention the bulk charge is of a temperature of 200-400° C. when entering the solids cooler. Then, it is cooled down to a temperature at which disposal or further use of the solid matter is feasible without any difficulty. In an exemplary embodiment the bulk charge is of a temperature of 50-150° C. when being discharged from the solids cooler.

The supplied gas which serves to substitute the void space gas is, for example, nitrogen, carbon dioxide, air or a mixture of these gases. The said gas is then discharged from the cooler in a mixture with the raw gas.

The flow rate of the gas supplied to the vessel through the lines permeable to gas is preferably controlled in such a manner that the velocity of the supplied gas on the outlet surface of the line permeable to gas is larger than or the same as the minimum fluidisation velocity of the bulk charge. The gas-conducting lines may be supplied individually or in groups with gas of variable flow rate. In a different way, the supplied gas rate may be rated such that at the free cross-sectional areas between the lines a gas velocity of the supplied gas is reached which is larger than or the same as the minimum fluidisation velocity of the bulk charge.

In an embodiment of the invention gas pulses are sent through the gas-conducting lines in flow direction of the solids from bottom to top and/or in a temporal sequence to counteract deposit formation of the bulk charge in the solids cooler. In another embodiment of the invention the bulk charge leaving the vessel is fluidised with further gas from at least one gas inlet nozzle in the discharge section such that a cooled and fluidised solid matter almost free of residual gas is obtained at the outlet nozzle.

In an embodiment of the invention it is possible to use gas pulses such that the pores or gas-permeable areas of the gas-conducting lines are cleaned or freed from plugging. These pulses consist of waves of increased gas pressure with the aid of which plugs or solid lumps or bridges formed can be removed by the increased gas pressure of the gas-conducting lines.

These are embodiments of the invention resulting from the described contrivance with supply section, cooling section and discharge section including heat-exchanging fluid-conducting lines and gas-exchanging gas-conducting lines. The invention has the advantage that a bulk charge separated from a gas generation unit and particularly from a coal gasification unit can be cooled down effectively, the gas contained in the bulk charge being able to be removed and the bulk charge being passed to further use or disposal.

The inventive embodiment of an inventive solids cooler is detailed in eleven drawings, the inventive contrivance not being restricted to these embodiments.

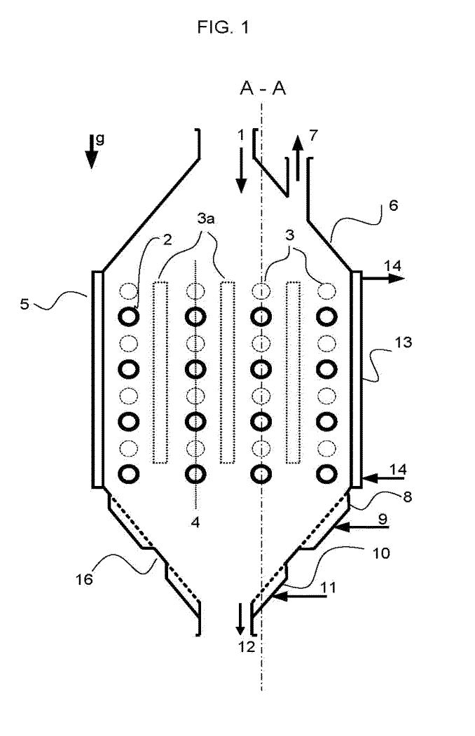

FIG. 1 shows an inventive solids cooler consisting of a supply section (6), a cooling section (5) and a discharge section (16). The bulk charge (1) enters and flows in flow direction g through the conical supply section (6) and comes into contact with two types of lines (2,3), the one type of lines (2) comprising fluid-conducting lines used for heat exchange and cooling of the bulk charge, and the other type of lines (3) being permeable to gas and used for gas supply into the bulk charge (1). These inject a gas into the bulk charge such that the residual gas contained in the particles is substituted by the gas and the particles are simultaneously fluidised. Some of the gas-conducting lines (3a) of a flattened cross-section are designed as gas-conducting hollow bodies. Fluid-conducting lines (2) and gas-conducting lines (3) of a round cross-section are arranged between and beside the gas-conducting lines (3a) of a flattened cross-section in parallel to the flow direction, with the gas-conducting and fluid-conducting lines (2,3) of a round cross-section alternating in flow direction of the solids. The wall (13) of the cooling section (5) is thermally conductive and provided with a jacket through which cooling agent (14) flows. The supply section (6) includes a gas relief nozzle (7) via which the gas from the supply section (6) can escape upon entry of the bulk charge. The discharge section (16) is provided with further gas inlet openings (8,10) for the supply of additional gas (9,11) for fluidising the bulk charge. The cooled and purified bulk charge (12) is removed from the conical discharge section (16). The fluid-conducting lines (2) and the gas-conducting lines (3) inside the cooling section (5) are arranged in line rows in flow direction of the solid, the line rows (4) of the fluid-conducting lines (2) and of the gas-conducting lines (3) alternating in flow direction of the bulk charge. On account of the integration of the gas supply lines the heat transfer area is, on the one hand, reduced by the given tube arrangement but, on the other hand the bulk material flow is ensured. As regards conventional shaft coolers it is known that the bulk charge passes through the rows of tubes at a very low cross-mixing rate and that gas strands already cooled move from top to bottom without any cross-mixing such that a considerable part of the still hot particles does not come into contact with the heat transfer agent or only very late. This results in that the heat transfer is not as high as theoretically estimated. The proposed arrangement in FIG. 1 shows, on the one hand, less heat transfer area because some of the tubes are used for gas supply. But, on the other hand, the gas supply causes a local fluidisation and hence cross-mixing such that a considerably more effective cooling of the bulk material can be achieved on the heat transfer areas designed as lines (2).

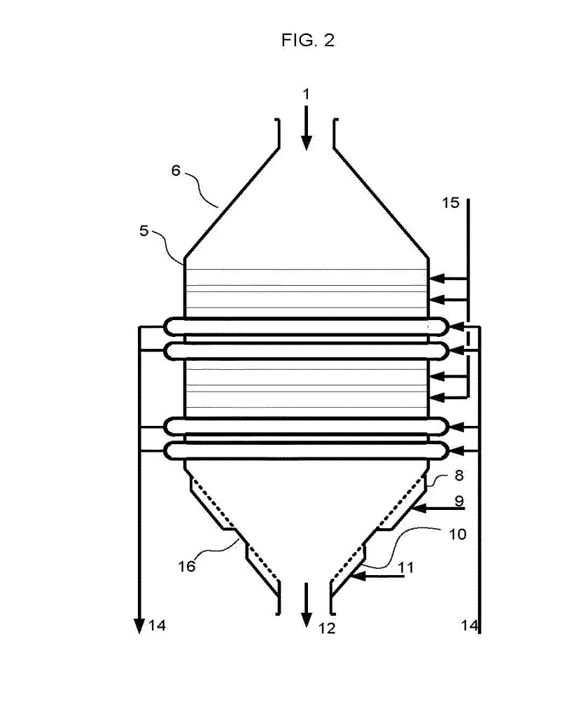

FIG. 2 shows the same inventive solids cooler in a sectional view A-A of FIG. 1 displaying the supply section (6), the cooling section (5) and the discharge section (16). The fluid-conducting lines (2) and the gas-conducting lines (3) extend across the cross-section of the vessel (5).

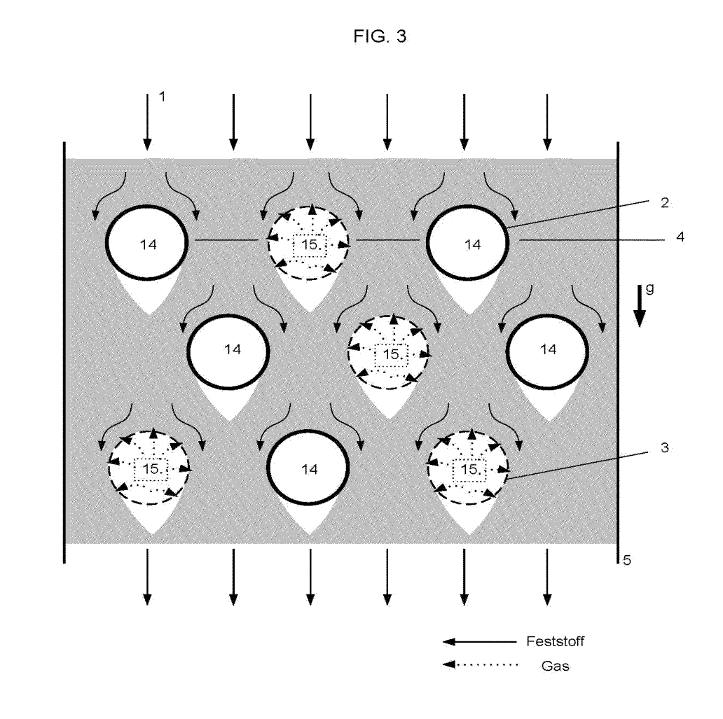

FIG. 3 only shows the inside of the cooling section (5) of the inventive solids cooler displaying the fluid-conducting lines (2) impermeable towards the inside of the cooling section and the gas-conducting lines (3) permeable to gas towards the inside of the cooling section (5) and which alternate in line rows (4) obliquely with respect to the flow direction of the solid. A gas (15) or a cooling agent (14) flows through these lines.

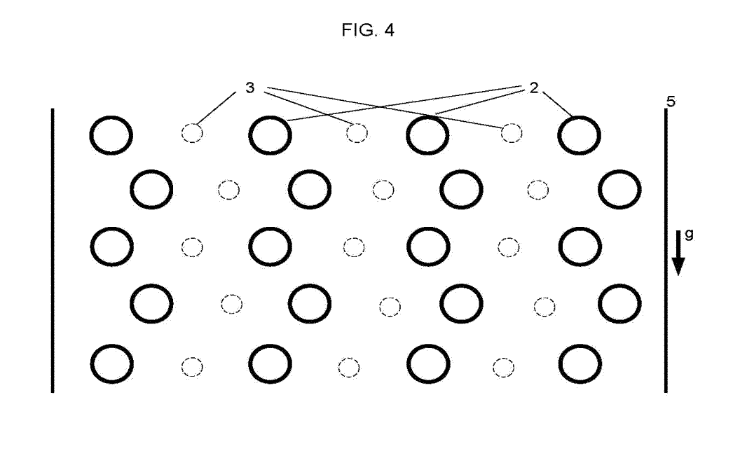

FIG. 4 only shows the inside of the cooling section (5) of the inventive solids cooler. The fluid-conducting lines (2) and the gas-conducting lines (3) inside the cooling section (5) are arranged in zigzag rows in flow direction, the rows of the fluid-conducting lines (2) and of the gas-conducting lines (3) alternating in flow direction of the bulk charge. The diameter of the gas-conducting lines (3) permeable to gas towards the inside of the cooling section (5) is smaller than that of the fluid-conducting lines (2). Based on the given tube arrangement, this results in a larger interspace and a larger free passage between the tubes for the solids flow.

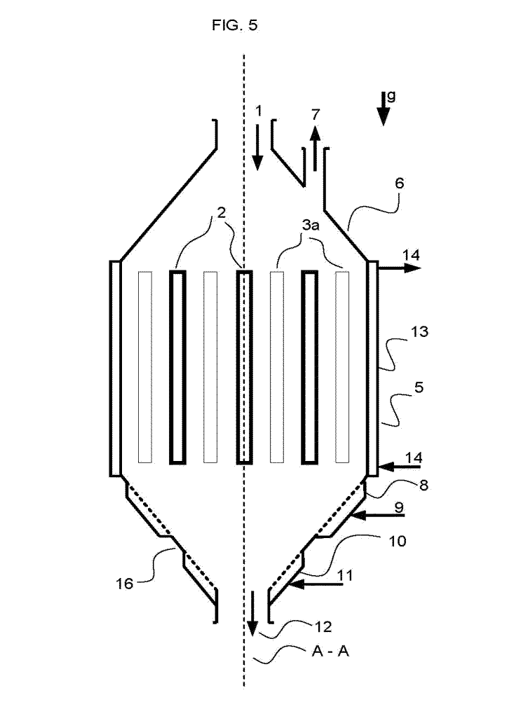

FIG. 5 shows the inside of the inventive solids cooler with supply section (6), cooling section (5) and discharge section (16). The fluid-conducting lines (2) and the gas-conducting lines (3) are of a flattened cross-section, in this case, for example, in the form of hollow bodies, the fluid-conducting lines (2) being impermeable towards the inside of the cooling section (5) and the gas-conducting lines (3) being permeable to gas towards the inside of the cooling section (5).

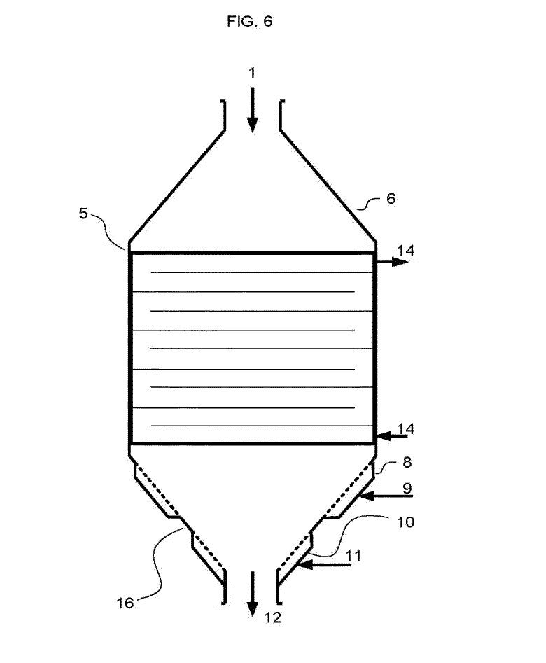

FIG. 6 shows the same inventive solids cooler (5) in a sectional view A-A of FIG. 6 displaying the supply section (6), the cooling section (5) and the discharge section (16). The cooling section (6) includes a line (2) of a flattened cross-section, in this case, for example, in the form of a hollow body, the inside being structured in meander form. The heat transfer areas can be provided with this structure for targeted flow control of the cooling agent (14).

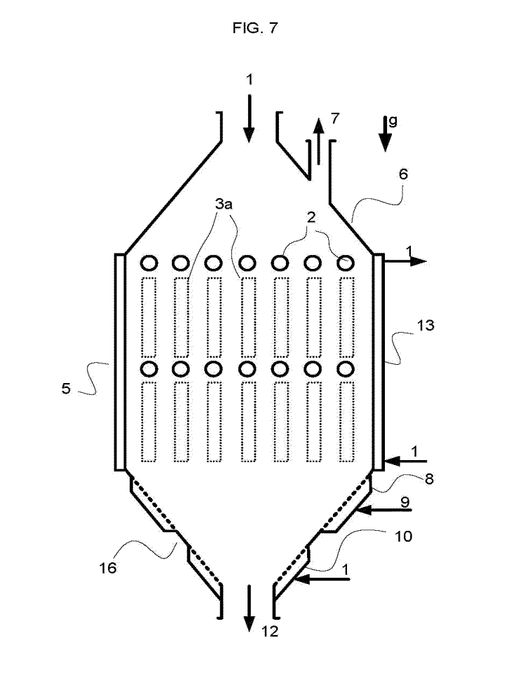

FIG. 7 shows the inside of the inventive solids cooler (5) with supply section (6), cooling section (5) and discharge section (16).

The gas-conducting lines (3a) are designed as lines of a rectangular cross-section, in this case, for example, in the form of hollow bodies. Gas-conducting lines (3a) of a round cross-section are arranged between and beside the fluid-conducting lines (2) aligned in parallel to the flow direction. Here, the gas-conducting lines (2) are arranged upstream of the entry of the bulk charge into the heat exchange zone as well as between the subsequent arrangement of the fluid-conducting hollow bodies. Charges of very fine particles are characterised by a specific gas retention capacity which can normally also be ascertained in the fly ash considered here. On account of the gas retention capacity of the solid, fluidisation takes place prior to the entry into the gaps between the fluid-conducting hollow bodies. Depending on the gas retention capacity, the velocity of the solids and the size of the vessel, it may be required, as shown by way of example in FIG. 7, to carry out one or several additional intermediate fluidisation operations.

### LIST OF REFERENCES USED

1 Entering solids to be cooled, bulk charge

2 Fluid-conducting lines

3 Gas-conducting lines

3a Gas-conducting lines with flattened cross-section

4 Line row

5 Cooling section or vessel

6 Supply opening

7 Gas relief nozzle

8 Gas supply nozzle

9 Supplied gas

10 Gas supply nozzle

11 Supplied gas

12 Cooled solid

13 Wall as heat transfer area

14 Fluid or cooling agent

15 Gas

16 Discharge section

g Flow direction of the bulk charge

1. A solids cooler for the cooling of a hot fine-grained bulk charge with simultaneous exchange of the void space gas contained between the bulk particles and inside their pores, comprising;
a vessel which serves as cooling section, at least one supply opening being arranged on the one side and at least one discharge for the bulk charge passing through being arranged on the opposite side, wherein;
the inside of the vessel is equipped with a first type of lines which are closed towards the inside of the vessel and can be passed by a fluid, thus facilitating an indirect heat exchange between the fine-grained bulk charge and the void space gas surrounding the latter and the fluid passing through the lines,
the inside of the vessel is equipped with a second type of lines which are permeable to gas towards the inside of the vessel and can be passed through by a gas which can permeate into the inside of the vessel through openings,
the vessel is equipped with a gas relief nozzle for the gas introduced by the second type of lines into the inside of the vessel as well as for the void space gas thus displaced, and
the cross-section of at least one gas-conducting line inside the vessel is extended in flow direction of the solids such that a line flattened in the cross-section is formed.

2. Solids cooler according to claim 1, wherein the cross-section of at least one fluid-conducting line inside the vessel is extended in flow direction of the solids such that a line flattened in the cross-section is formed.

3. Solids cooler according to claim 1, wherein a plurality of fluid-conducting or gas-conducting lines, the cross-section of which is flattened in flow direction of the solids, is installed in flow direction of the solids.

4. Solids cooler according to claim 1, wherein at least one gas-conducting line or one fluid-conducting of line of a round cross-section is arranged between the fluid-conducting or gas-conducting lines of a cross-section flattened in flow direction of the solids and provided in plurality in flow direction of the solids.

5. Solids cooler according to claim 1, wherein the diameter of the second type of gas-conducting lines is smaller than the diameter of the first type of fluid-conducting lines.

6. Solids cooler according to claim 1, wherein the gas relief nozzle and the supply opening for the bulk charge are arranged on the same side.

7. Solids cooler according to claim 1, wherein the first type of fluid-conducting lines and the second type of gas-conducting lines inside the vessel are arranged in rows in flow direction of the solids with reference to the vessel cross-section, the rows of the first type of fluid-conducting lines and of the second type of gas-conducting lines alternating in flow direction of the solids with reference to the vessel cross-section.

8. Solids cooler according to claim 1, wherein the first type of fluid-conducting lines and the second type of gas-conducting lines inside the vessel are arranged in rows obliquely with respect to the flow direction of the solids with reference to the vessel cross-section, the rows of the fluid-conducting lines and those of the gas-conducting lines alternating obliquely with respect to the flow direction of the solids with reference to the vessel cross-section.

9. Solids cooler according to claim 1, wherein the first type of fluid-conducting lines and the second type of gas-conducting lines inside the vessel, are arranged in zigzag rows opposite the flow direction of the solids with reference to the vessel cross-section, the rows of the fluid-conducting lines and of the gas-conducting lines alternating in flow direction of the solids.

10. Solids cooler according to claim 8, wherein the cross-section of at least one fluid-conducting line and one gas-conducting line inside the vessel is extended in flow direction of the solids, the fluid-conducting and gas-conducting lines alternating obliquely with respect the flow direction of the solids.

11. Solids cooler according to claim 1, wherein obliquely to the flow direction of the solids further lines of a round cross-section are located between the fluid-conducting lines of a cross-section flattened in flow direction of the solids, the gas-conducting or fluid-conducting lines of a round cross-section alternating in flow direction of the solids.

12. Solids cooler according to claim 1, wherein at least part of the gas-conducting lines are made of a porous material.

13. Solids cooler according to claim 12, wherein the porous material is a sintered ceramics, porous ceramics, porous plastics or sintered metal.

14. Solids cooler according to claim 1, wherein the gas-conducting lines for gas injection into the solids are provided with holes, bores, apertures or slots.

15. Solids cooler according to claim 1, wherein a gas inlet nozzle for gas to be supplied is provided upstream or downstream of the vessel in flow direction of the solids.

16. Process for the cooling of a fine-grained and hot bulk charge with simultaneous exchange of the void space gas contained between the bulk particles and inside their pores, in which:
the bulk charge to be cooled is fed to a vessel equipped with lines, and
the bulk charge is continuously moved through the vessel, wherein;
a heat transfer agent cooler than the bulk charge flows through a first type of lines such that an indirect heat exchange between the bulk charge and the heat transfer agent takes place,
a second type of lines is designed to be permeable to gas which serve to introduce a supplied gas into the vessel and into the bulk charge,
the void space gas contained between the bulk particles and inside their pores is displaced by the supplied gas and discharged,
gas can also escape via a gas supply nozzle upstream or downstream of the vessel in direction of the solids, and
the supplied gas is pre-heated up to the temperature of the supplied solid bulk charge.

17. Process according to claim 16, wherein the process for the generation of the bulk charge is a coal gasification, the bulk charge mainly consisting of fly ash or solidified slag or both.

18. Process according to claim 16, wherein the heat exchange agent is a liquid.

19. Process according to claim 18, wherein the heat exchange agent is water.

20. Process according to claim 16, wherein the solids are moved through the solids cooler by gravity or by a pressure gradient or by a combination of both.

21. Process according to claim 16, wherein the bulk charge is cooled down to a temperature of 150-50° C.

22. Process according to claim 16, wherein the gas supplied is nitrogen, carbon dioxide, air or a mixture of these gases.

23. Process according to claim 16, wherein the flow rate of the gas supplied to the vessel through the lines permeable to gas is controlled in such a manner that the velocity of the supplied gas, referred to the gas outlet area of the lines permeable to gas, is larger than or the same as the minimum fluidisation velocity of the entering bulk charge.

24. Process according to claim 16, wherein the gas-conducting lines are supplied individually or in groups with gas of variable flow rate.

25. Process according to claim 24, wherein gas pulses are sent through the gas-conducting lines in flow direction of the solids from bottom to top and/or in a temporal sequence to counteract deposit formation of the solids in the solids cooler.

26. Process according to claim 16, wherein the solids leaving the vessel is fluidised with supplied gas from at least one gas inlet nozzle in the discharge section of the bulk charge such that a cooled and fluidised bulk charge almost free of residual gas is obtained at the discharge section.
